(19) United States
(12) Patent Application Publication
(10) Pub. No.: US 2003/0189049 A1
(43) Pub. Date: Oct. 9, 2003

(54) Storage container opener/closer

(76) Inventor: Jeffrey Schneebaum, East Meadow, NY (US)

Correspondence Address: Neal L. Rosenberg, Esq, AMSTER, ROTHSTEIN & EBENSTEIN, 90 Pork Avenue, New York, NY, 10016, US

(21) Appl. No.: 10/115,419

(22) Filed: Apr. 3, 2002

(51) Int. Cl. B21D 51/26; B67B 3/00; B67B 7/16; B65D 51/00

(52) U.S. Cl. 220/286; 220/212; 53/332; 53/484; 53/492; 81/3.57

(57) ABSTRACT

A manually operable rigid device defines a generally V-shaped groove opening onto an outer face thereof for closing a storage container in a multi-step process by bending a flexible, upstanding peripheral rim thereof over a margin of a central cover. A manually operable rigid device defines a wedge having a tip for opening a storage container in a multi-step process by unbending the previously bent rim thereof.

### BACKGROUND OF THE INVENTION

The present invention relates to a device for opening/closing a storage container, and a process useful therewith, and more particularly to such a device and process for opening/closing an aluminum foil take-out container of the type used for fast foods.

It is quite common for fast food establishments to utilize aluminum foil storage containers for the storage of take-out foods during delivery. The food is placed in an open-top storage container having a flexible, upstanding peripheral rim, and then a central cover is placed over the open top of the container. The flexible, upstanding peripheral rim is then manually bent over a margin of the central cover. Once the food is delivered to the consumer, the consumer manually unbends the flexible peripheral rim sufficiently to allow for removal of the central cover and exposure of the food within the container.

Both the closing of the container and the opening of the container are typically performed without the use of any tools or devices which might facilitate these operations and/or reliably ensure the performance of these operations. Thus it is not unusual that the closing operation results in a portion of the peripheral rim only loosely covering the cover margin, with the result that there is liquid (or even solid) leakage from the container cavity. The result is not only a loss of some of the food from the cavity onto the outer surface of the container (and a general mess) but, on occasion, the escaped contents will damage any bag or other wrap in which the container is placed for delivery. In any case, the closing operation is both time-consuming and tiring to the individual in a commercial fast food establishment, who may have to rapidly close many containers during the course of a rush hour.

Further, after delivery of the container to the consumer, the consumer, especially if older, arthritic or otherwise manually impaired, may find it difficult to unbend the peripheral rim sufficient to enable easy removal of the central cover from the container. Occasionally, to avoid damage to fingernails, the consumer may employ a knife or fork for this purpose. This has been known to result in accidental stabbing of the user by the knife or fork and is therefore a practice to be discouraged. Typically, the knife or fork is used to pry up (i.e., unbend) a short length of the peripheral rim, and then the prying is repeated at a number of locations along the circumference or inner edge of the bent peripheral rim, until the peripheral rim has been unbent sufficiently for the user to manually grab the unbent rim portions and manually (i.e., without the use of any tool) unbend the remainder of the peripheral rim. This common but time-consuming practice is also to be discouraged because the edge of the peripheral rim may be sharp, and the user's hand can be cut by the rim edge during the manual prying process.

Accordingly, it is an object of the present invention to provide in one embodiment a device for closing a storage container which safely and efficiently ensures tight bending of the peripheral rim over the central cover margin, thereby to prevent leakage from the container cavity.

Another object is to provide a device in another embodiment for opening a storage container which safely and efficiently unbends the bent peripheral rim of a storage container to enable removal of the central cover therefrom.

A further object is to provide in one embodiment such a device which may be used both for opening and closing a storage container, as needed.

It is also an object of the present invention to provide a process using one of the above devices for safely and efficiently opening or closing a storage container.

### SUMMARY OF THE INVENTION

It has now been found that the above and related objects of the present invention are obtained in a closing device and an opening device.

The device for closing a storage container by bending a flexible upstanding peripheral rim thereof over a margin of a central cover comprises a manually operable rigid member defining a groove opening onto an outer face thereof and configured (A) for forcibly pressing the groove onto an initial length of a flexible upstanding peripheral rim of a storage container to bend the initial rim length downwardly and inwardly so that the initial rim length overlaps an initial length of the edge of the central cover, and (B) for forcibly moving the groove laterally along the remaining length of the rim to bend the remaining rim length so as to overlap the remaining length of the cover margin.

In a preferred embodiment of the closing device, the groove is configured and dimensioned to bend the rim to an orientation substantially parallel to the cover. The groove is defined by a variable groove angle, and the groove angle is preferably greatest at each lateral end of the device, and progressively decreases towards the middle thereof.

The device for opening a storage container by unbending a flexible peripheral rim thereof previously bent to substantially overlap a margin of a central cover comprises a manual operable rigid member having a wedge portion formed from two opposed end wedges and an intermediate wedge connecting the two end wedges, the end wedges being sharper than the intermediate wedge. The end and intermediate wedges share a common bottom surface and have respective upper surfaces that merge togther. Specifically, the upper surfaces of the end wedges merge smoothly and upwardly into the upper surface of the intermediate wedge. This shape facilitates initially forcibly inserting at least one of the relative sharp end wedges intermediate an initial length of a margin of a central cover and an initial length of a flexible overlapping peripheral rim of an aluminum storage container to unbend the initial rim length upwardly and outwardly relative to the initial cover margin length so that the initial rim length no longer substantially overlaps the initial cover margin length, and then, after partial rotation of the member to replace the one end wedge by the intermediate wedge, forcibly moving the intermediate wedge laterally intermediate the remaining length of the cover margin and the remaining length of the rim to unbend the remaining rim length so that the remaining rim length no longer substantially overlaps the remaining cover margin length.

In a preferred embodiment of the opening device, the intermediate wedge is configured and dimensioned to unbend the rim to an orientation at least substantially perpendicular to the cover. The intermediate wedge is defined by a variable wedge angle, and the intermediate wedge angle is smallest at each lateral end thereof, and progressively increases towards the middle of the intermediate wedge.

Alternatively, the opening device comprises a manually operable rigid member including a bottom surface defining one surface of a wedge extending between lateral ends of the member. The wedge has a variable wedge angle which is smallest at the lateral ends and progressively increases towards the front of the member, wherein one of the smallest wedge angles facilitates insertion of the member intermediate the bent rim and adjacent cover and the progressively increasing wedge angle thereafter facilitates the unbending of the bent rim as the member is moved around the storage container.

The present invention still further encompasses a single or combination device for both closing a storage container by bending a flexible upstanding peripheral rim thereof over a margin of a central cover, and for opening a storage container by unbending a flexible peripheral rim thereof previously bent to substantially overlap a margin of a central cover. The single device comprises a manually operable rigid member defining a groove having an opening and a wedge having a tip. To close the container one initially forcibly presses the groove inwardly onto an initial length of an outer surface of a flexible upstanding peripheral rim of a storage container to bend the initial rim length downwardly and inwardly so that the initial rim length overlaps an initial length of a margin of a central cover and then forcibly moves the groove laterally along the remaining length of the rim to bend the remaining rim length so that it overlaps the remaining length of the cover margin. To open the container one initially forcibly inserts at least the wedge tip intermediate an initial length of the cover margin and an initial length of the overlapping rim to unbend the rim length upwardly and outwardly relative to the cover so that the initial rim length no longer substantially overlaps the initial cover margin length and then forcibly moves at least the wedge tip laterally intermediate the remaining length of the cover margin and the remaining length of the rim to unbend the remaining rim length so that it no longer substantially overlaps the remaining cover margin length.

Preferably, the wedge is sharp at each end of the device and relatively blunt intermediate the ends of the device. A rotatable member may be disposed on at least one of the facing surfaces of the groove or at least one of the opposed surfaces of the wedge to facilitate lateral movement thereof.

In a preferred embodiment of the single or combination device, the manual operable rigid member defines two opposed end wedges and an intermediate wedge connecting the two wedges, the end wedges being sharper than the intermediate wedge. The end and intermediate wedges are defined by a common bottom surface and upper surfaces, the upper surfaces of the end wedges expanding smoothly upwardly into the upper surface of the intermediate wedge (A) for initially forcibly inserting at least one of the initial end wedges intermediate an initial length of the central cover margin and an initial length of the flexible overlapping peripheral rim of the aluminum storage container to unbend the initial rim length upwardly and outwardly relative to the initial cover margin length so that the initial rim length no longer substantially overlaps the initial cover margin length, and (B) then, after partial rotation of the member to replace the one end wedge by the intermediate wedge, for forcibly moving the intermediate wedge laterally intermediate the remaining length of the cover margin and the remaining length of the rim to unbend the remaining rim length so that the remaining rim length no longer substantially overlaps the remaining cover margin length.

Alternatively, the single or combination device comprises a manually operable rigid member defining a groove and a wedge. The groove has a variable groove angle which is largest at the lateral ends and progressively decreases towards the middle of the member, wherein one of the largest groove angles facilitates insertion of the member over the rim and adjacent cover, and the progressively decreasing groove angle thereafter facilitates the bending of the rim as the member is moved around the storage container. The wedge has a variable wedge angle which is smallest at the lateral ends and progressively increases towards the front of the member, wherein one of the smallest wedge angles facilitates insertion of the member intermediate the bent rim and adjacent cover, and the progressively increasing wedge angle thereafter facilitates the unbending of the bent rim as the member is moved around the storage container.

In a combination embodiment of the invention, one of the single or combination devices defined hereinabove is combined with a container/cover assembly including a storage container having a flexible upstanding peripheral rim, and a central cover having a peripheral margin. The rim is bendable to substantially overlap the cover margin, thereby to close the container with the cover and, when previously so bent, being unbendable to not substantially overlap the cover margin, thereby to open the container for removal of the cover therefrom.

Preferably, the rigid member is formed of plastic having a low coefficient of friction, the device additionally includes a finger ring secured to the member for movement therewith and wearable on a user's finger, and a rotatable member (such as a cylindrical roller or a ball bearing) is disposed on at least one of the opposed surfaces of the intermediate wedge or one of the facing surfaces of the groove to facilitate lateral movement of the rigid member.

The present invention additionally encompasses processes for closing and opening the storage containers.

The process for closing a storage container by bending a flexible upstanding peripheral rim thereof over a margin of a central cover comprises the steps of providing a manually operable rigid device defining a generally V-shaped groove opening onto an outer face thereof, and initially forcibly pressing the groove of the device inwardly onto an initial length of an outer surface of a flexible upstanding peripheral rim of a storage container to bend the initial rim length downwardly and inwardly, so that the initial rim length overlaps an initial length of a margin of a central cover. The next step involves forcibly moving the groove of the device laterally along the remaining length of the rim to bend the remaining rim length so that it overlaps the remaining length of the cover margin, and then finally separating the device and the container.

The process for opening a storage container by unbending a flexible peripheral rim thereof previously bent to substantially overlap a margin of a central cover comprises the steps of providing a manual operable rigid device defining a wedge having a tip, and initially forcibly inserting at least the tip of the wedge intermediate an initial length of a margin of a central cover and an initial length of a bent flexible peripheral overlapping rim of a storage container to unbend the initial rim length upwardly and outwardly relative to the initial cover margin length, so that the initial rim length no longer substantially overlaps the initial cover margin length. The next step involves forcibly moving at least the wedge tip laterally intermediate the remaining length of the cover margin and the remaining length of the rim to unbend the remaining rim length so that the remaining rim length no longer substantially overlaps the remaining cover margin length, and finally separating the device and the container.

In a preferred embodiment, the wedge is relatively sharp at each lateral end of the device and relatively blunt intermediate the lateral ends of the device, and the initial insertion step involves insertion of a sharp wedge end, followed by partial rotation of the device to forcibly insert the blunt intermediate portion of the wedge. Preferably the wedge is flat (sharp) at each lateral end of the device and thick (blunt) intermediate the lateral ends of the device.

### BRIEF DESCRIPTION OF THE DRAWING

The above and related objects, features and advantages of the present invention will be more fully understood by reference to the following detailed description of the presently preferred, albeit illustrative, embodiments of the present invention when taken in conjunction with the accompanying drawing wherein:

FIGS. 1, 2 and 3 are top plan, front elevational and side elevational views, respectively, of a device according to the present invention;

FIGS. 4-7 are fragmentary views schematically showing the device in the process of closing a storage container, FIGS. 4 and 5 being sectional views showing the device being progressively initially pressed onto a container, FIG. 6 being a top plan view showing the device completely initially pressed onto the container, and FIG. 7 being a sectional view taken along the line 7-7 of FIG. 6;

FIG. 8 is a top plan view, to a reduced scale, showing the device being moved 360° laterally around the container;

FIGS. 9-10 are fragmentary views schematically showing the device in the process of opening a storage container, FIG. 9 being a sectional view showing the initial insertion step, and FIG. 10 being a top plan view, showing the device after reorientation thereof;

FIG. 11 is a top plan view, to a reduced scale, showing (after reorientation of the device) the device being moved 360° around the container; and

FIG. 12 is an isometric view to an enlarged scale of the device.

### DETAILED DESCRIPTION OF THE PREFERRED EMBODIMENTS

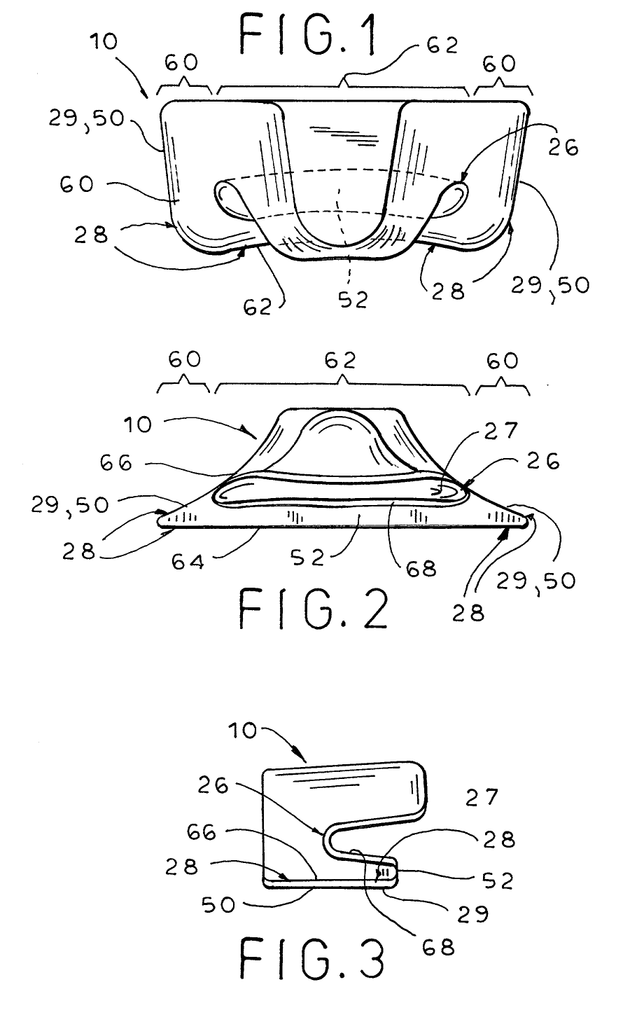

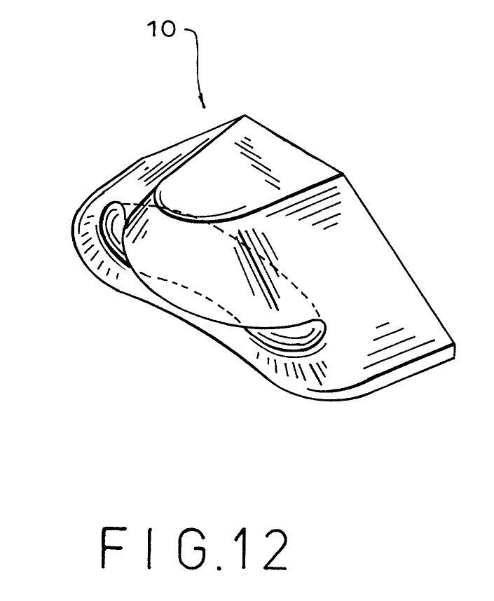

Referring now to the drawings, and in particular to FIGS. 1 and 12 thereof, therein illustrated is a tool or device according to the present invention, generally designated by the reference numeral 10, for closing a storage container by bending a flexible, upstanding peripheral rim thereof over a margin of a central cover, for opening a storage container by unbending a flexible peripheral rim thereof previously bent to substantially overlap a margin of the central cover, or both. The device 10 is a rigid, manually operable construction defining a V-shaped groove opening onto an outer face thereof, defining a wedge with a tip forming a variable wedge angle on an outer face thereof, or both. The device 10 is configured and dimensioned to be easily grasped in one hand by a user thereof.

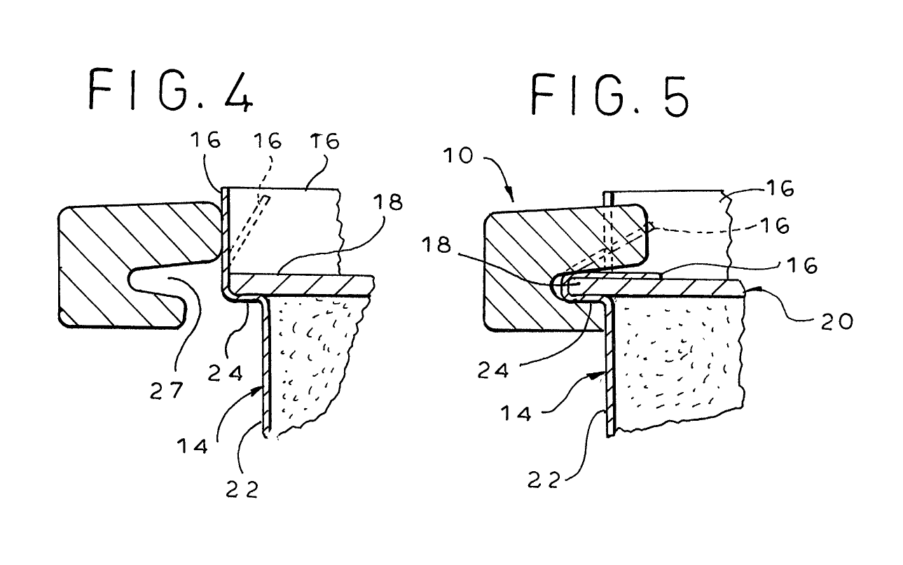

Referring now to FIGS. 4-8, therein illustrated schematically is use of the device 10 for closing a storage container, generally designated 14, by bending a flexible, upstanding peripheral rim 16 thereof over the peripheral margin 18 of a central cover, generally designated 20. The storage container 14 is illustrated as being circular in plan, although clearly the principles of the present invention also apply to the closing of storage containers of different configurations, including polygonal configurations, especially rectangular configurations with rounded corners. The flexible, upstanding peripheral rim 16 of the container 14 is typically offset outwardly from the main body 22 of the container so as to form a substantially horizontal ledge 24 for receipt and support of the peripheral margin 18 of cover 20. The rim 16 is typically of sufficient height that, when bent inwardly and downwardly, it extends over the ledge 24 and optionally even further inwardly over the container main body 22. The cover border or peripheral margin 18 supported by the ledge 24 is optionally spaced a distance above the normal top level of the food or other product within the cavity of the container 14.

The container 14 is typically formed of aluminum foil, but clearly other materials capable of providing a suitable delivery container may be employed. Such other materials should provide a bendable, upstanding peripheral rim which, once bent, will retain the bent configuration until it is forcibly unbent.

The cover 20 may be formed of a thick paper or a laminate which provides a heat-reflecting surface facing the container cavity. Alternatively, the cover may be formed of plastic, preferably a transparent plastic to enable viewing of the contents of the container therethrough.

As the storage container 14 and cover 20 described hereinabove are conventional in nature and well known in the art, it is not deemed necessary to provide further details thereof herein.

The device 10 according to the present invention is intended for use in a multi-step method, whether that be a multi-step method for closing a storage container or a multi-step method for opening a storage container. As will be explained more fully hereinafter, the structure of the device 10 lends itself to such multi-step operations and provides benefits arising out of such multi-step operations.

Thus, the manually operable rigid device 10 for closing a storage container 14, by bending a flexible, upstanding peripheral rim 16 thereof over a margin 18 of a central cover 20, defines a generally V-shaped groove, generally designated 26, having an opening 27 on an outer face of the device. The generally V-shaped groove 26 may be rounded at the vertex thereof so that the vertex more closely resembles the base of a “U,” as shown in FIG. 3.

Referring now to FIGS. 4-7 in particular, in the initial step of the multi-step closing process, the user initially forcibly presses the opening 27 of groove 26 inwardly onto an initial length 30 of an outer surface of the rim 16 to bend the initial rim length 30 downwardly and inwardly so that the initial rim length 30 overlaps an initial length 32 of the cover margin 18. The lengths of the initial rim and cover margin lengths 30, 32 will depend upon the length of the groove 26. Preferably the groove 26 is relatively short so that the initial lengths 30, 32 are relatively short and therefore only a minimum of force is required to effect the desired deformation of the initial rim length 30.

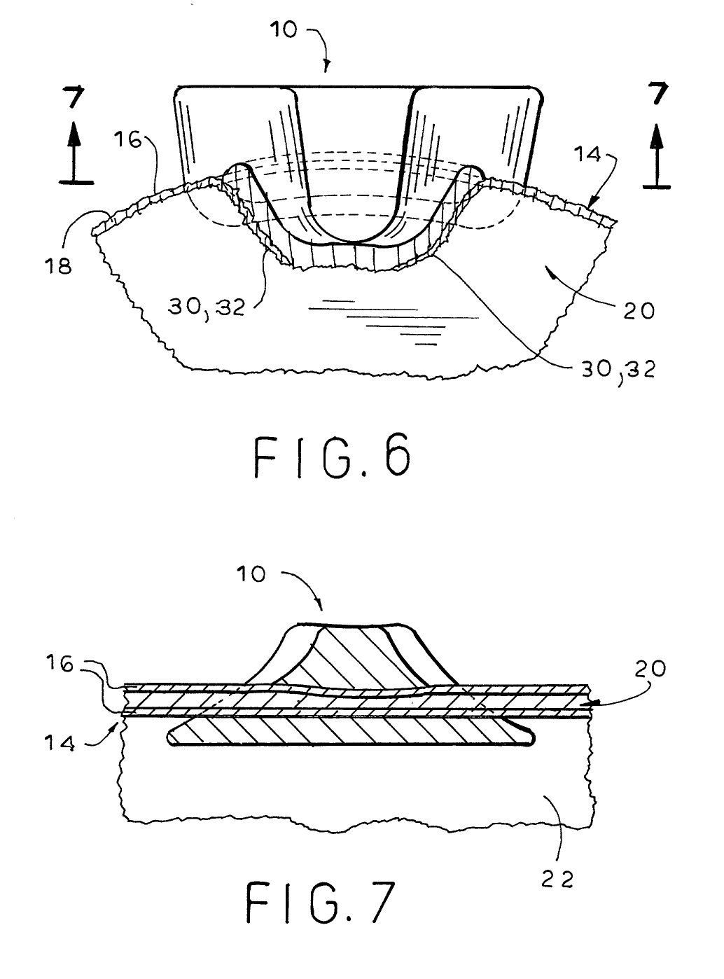

Referring now to FIG. 8 in particular, in the next step, the user forcibly moves the groove 26 laterally along the remaining length 34 of the rim 16 (see double-headed arrow 33) to bend that remaining rim length 34 so that it overlaps the remaining length 36 of the cover margin. As will be explained in further detail hereinafter, the groove 26 is configured and dimensioned to facilitate this lateral movement along the remaining rim and cover margin lengths 34, 36 with minimum effort. Finally, the device 10 and the now-closed container 14 are separated.

Similarly, the manually operable rigid device 10 for opening a storage container 14, by unbending a flexible peripheral rim 16 thereof previously bent to substantially overlap a margin 18 of a central cover 20, defines a wedge, generally designated 28, having a tip 29 on an outer face of the device on at least one lateral end thereof (as illustrated, on each lateral end thereof).

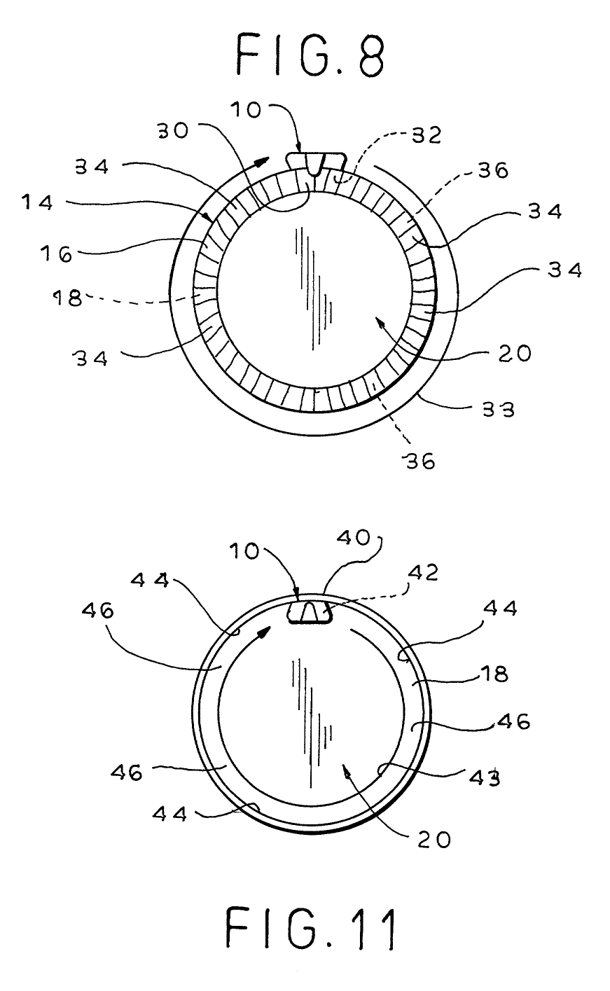

Referring now to FIG. 9 in particular, in the initial step of the multi-step opening process, the user initially forcibly inserts tip 29 of wedge 28 intermediate an initial length 40 of a bent, flexible, peripheral rim 16 and an initial length 42 of a cover margin 18 and thereafter rotates the device to the orientation shown in FIG. 10 to unbend the initial rim length 40 upwardly and outwardly relative to the initial cover margin length 42, so that the initial rim length 40 no longer substantially overlaps the initial cover margin length 42. The lengths of the initial rim and cover margin lengths 40, 42 will depend upon the length of the wedge tip 29. Preferably the wedge tip 29 is relatively short so that the initial lengths 40, 42 are relatively short and only a minimum of force is required to effect the desired deformation of the initial rim length 40.

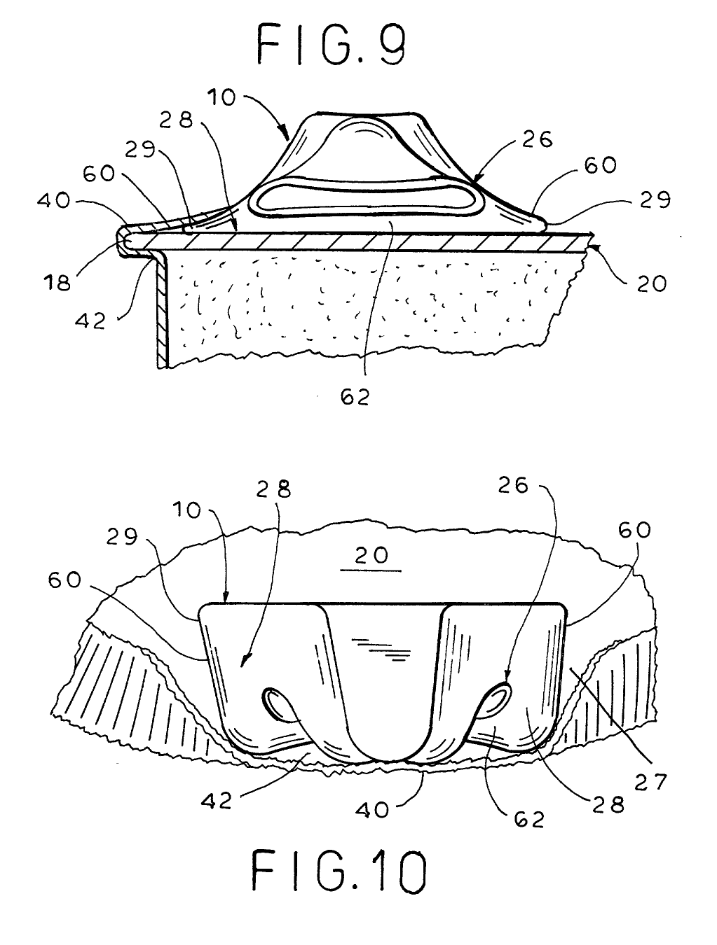

Referring now to FIG. 11 in particular, in the next step the user forcibly moves at least the wedge tip 29 laterally intermediate the remaining length 44 of rim 16 and the remaining length 46 of cover margin 18 (see double-headed arrow 43) to unbend the remaining rim length 44 so that the remaining rim length 44 no longer substantially overlaps the remaining cover margin length 46. As will be explained in further detail hereinafter, the wedge 28 is configured and dimensioned to facilitate this lateral movement along the remaining rim and cover margin lengths 44, 46 with minimum effort. Finally, the device 10 and the now-open container 14 are separated, the cover 20 now being easily separable from the container 14 without substantial flexing of the cover.

As will be apparent from the overview provided hereinabove, the closing process involves both an initial forcible pressing step and a subsequent forcible lateral moving step. Similarly, the opening process involves an initial forcible inserting step and a subsequent forcible lateral moving step. In each process, the initial pressing or inserting step acts on only a limited length 30 or 40 of the rim 16 (either to bend or unbend the same), while in each process the subsequent lateral movement step acts on the remaining length 34 or 44 of the rim 16 (either to bend or unbend the same). In both the opening and closing processes, the configuration and dimensions of the device 10 ensure that, once the initial pressing or inserting step is completed, the subsequent lateral movement step is safely and efficiently performed, ordinarily with less force being required than was for the initial step.

It will be appreciated that, in the case of a circular container 14, the initial step of the closing process involves a radially inward movement of the device 10, while the initial step of the opening process involves a radially outward movement of the device 10. Accordingly, the initial step of each process may be considered as a radial movement step, while the second step of each process may be considered as a circumferential movement step.

The initial rim and cover margin lengths 30, 32 referenced in connection with the closing process may or may not be the same as the initial rim and cover margin lengths 40, 42 referenced in connection with the opening process. Similarly, the remaining rim and cover margin lengths 34, 36 referenced in connection with the opening process may or may not be the same as the remaining rim and cover margin lengths 44, 46 referenced in connection with the opening process.

To facilitate the opening process, preferably the wedge 28 forms a relative sharp tip at each lateral end 50 of the device 10 but is relatively blunt in a middle portion 52 intermediate the lateral ends 50 of the device. In other words, the wedge 28 at each lateral end 50 of the device has a relatively small or sharp wedge angle which blends to a relatively thick or blunt wedge angle at the middle portion 52 intermediate the lateral ends 52 of the device. As shown in FIG. 3, middle portion 52 forms an upstanding edge approximately perpendicular to the bottom surface of the device. During the initial insertion step, once one of the sharp wedge ends 50 is inserted intermediate the initial rim length 40 and the initial cover margin length 42 (as seen in FIG. 9), the device 10 is partially rotated (i.e., reoriented, typically about 90°) to forcibly insert the blunt middle portion 52 of the wedge intermediate the initial rim length 40 and initial cover margin length 42 so that the blunt middle portion 52 forces the rim portion in contact therewith into an upward and outward position (as seen in FIG. 10). The purpose of this partial rotation or reorientation is to enable the sharp wedge end 50 (rather than the blunt middle wedge portion 52) to initiate the unbending process involved in the lateral movement step at all points along the remaining rim length 44. This results in a smoother, easier opening process.

While the present invention is illustrated using a single device 10 which incorporates both the groove 26 and wedge 28, clearly the present invention also encompasses a device which has only one of the groove or wedge. The obvious advantage in combining both the groove and the wedge in a single device 10 is that both are maintained readily available for use as circumstances arise.

Turning now to the construction of the device 10 itself, and referring now to FIGS. 1 through 3 in particular, as earlier mentioned the manually operable rigid member for closing a storage container defines a groove 26 having an opening 27 in the outer face thereof and is appropriately configured and dimensioned for the closing operation, while the manually operable rigid member for opening a storage container defines a wedge 28 having a tip 29 on the outer face thereof and is configured and dimensioned for the opening operation.

More particularly, the groove 26 is generally V-shaped and preferably defined by a variable groove angle. The groove 26 is configured and dimensioned so that the initial rim length 30 is only partially bent inwardly and downwardly upon its initial contact with the groove opening 27 at the front of the device 10, and becomes progressively further bent as the initial rim length 30 enters into the groove 26 towards the base or vertex thereof.

In a preferred embodiment of the closing device, as best seen in FIGS. 2 and 3, the groove 26 defines a compound curvature (preferably at its upper surface) with the groove angle being greatest at the lateral ends 50 of the device 10 (that is, the lateral sides of the groove opening 27) and progressively decreasing towards the middle portion 52 of the device 10 (or groove 26). The compound nature of the curvature facilitates both the initial pressing step and the subsequent lateral movement step. As best seen in FIG. 6, only the central or middle portion of the initial rim length 30 is fully depressed by the decrease in the groove angle at the middle portion 52 of the groove 26 so that less force is required to accomplish the initial pressing step. Further, the relatively open nature of the groove angle where it is greatest, at each lateral end 50 of the device (or groove 26), enables the lateral movement step at all points along the travel path to gradually and progressively bring the remaining rim length 34 into its fully bent state with minimum application of force.

The groove 26 is configured and dimensioned so that at least the vertex of the groove middle portion 52 (intermediate the lateral ends 50) bends the rim 16 to an orientation substantially parallel to the cover 20, thereby to uniformly effect a leakproof tight seal. To recapitulate, the compound nature of the preferred groove curvature facilitates both steps of the multi-step closing process.

As noted above, the manually operable rigid member defines a wedge 28 configured and dimensioned for opening storage container 14. The wedge 28 is preferably defined by a variable wedge angle. The wedge angle is smallest (that is, forming a sharper wedge) at each lateral end 50 of the wedge 28 and progressively increases (that is, forming a blunter wedge) towards the middle portion 52 thereof. The wedge 28 is configured and dimensioned so that the initial rim length 40 is only partially bent upwardly and outwardly upon its initial contact with the wedge at a lateral end of the device 10, and becomes progressively further bent upwardly and outwardly as the initial rim length 40 comes into contact with the middle portion 52 of wedge 28.

Like the groove 26, the wedge 28 may define (preferably at its upper surface) a compound curvature, thereby to facilitate both the initial insertion step and the subsequent lateral movement step of the opening operation. The wedge 28 is blunt at the front or middle portion 52 thereof and progressively becomes sharper towards the lateral ends 50 thereof. The compound nature of the curvature facilitates both the initial insertion step and the subsequent lateral movement step. As best seen in FIGS. 9 and 10, the relatively sharp wedge angle at each lateral end 52 of wedge 28 enables the easy insertion of the device end 52 intermediate the cover margin 18 and overlapping peripheral rim 16. The central or middle portion of the initial rim length 40 is thereafter fully opened (i.e. unbent) by the blunt middle portion 52 of the wedge 28.

The wedge 28 is configured and dimensioned so that at least the front of the wedge middle portion 52 (intermediate the lateral ends 50) unbends the rim 16 to an orientation substantially perpendicular to the cover 20, thereby to facilitate easy removal of the cover 20 from the container 24 without undue flexing of the cover 20.

To recapitulate, the compound nature of the preferred wedge curvature facilitates both steps of the multi-step opening process.

Referring now again to FIGS. 1-3 and 9-10, with regard to the configuration of the wedge 28, it is instructive to consider the device 10 as having a wedge 28 defined by two opposed end wedges 60 (at the device lateral ends 50) and an intermediate wedge 62 (at the device middle portion 52) connecting the two end wedges 60. The end wedges 60 are sharper than the intermediate wedge 62—that is, the laterally extending tip of each end wedge 60 forms a flatter angle than the relatively blunt and thick forward-facing tip of the intermediate wedge 62.

More particularly, the end and intermediate wedges, 60, 62, 60 define a common bottom surface 64 and separate upper surfaces 66, 68, 66, respectively. The upper surfaces 66 of the end wedges 60 expand or morph smoothly upwardly into the upper surface 68 of the intermediate wedge 62. The user initially forcibly inserts at least one of the end wedges 60 intermediate an initial rim length 40 and an initial cover margin length 42 to unbend the initial rim length 40 upwardly and outwardly relative to the initial cover margin length 42, so that the initial rim length 40 no longer substantially overlaps the initial cover margin length 42. The initial rim length 40 may still overlay a part of the initial cover margin length 42, but is raised slightly upwardly therefrom so that the two are no longer in contact.

At this point, the smooth transition from the end wedge upper surface 66 to the intermediate wedge upper surface 68 enables the user to partially rotate the member (i.e., reorient it, preferably by about 90°) to replace the inserted one end wedge 60 by the intermediate wedge 62 (and, more particularly, to replace the tip of the inserted end wedge 60 by the tip of the intermediate wedge 62). It will be appreciated that this reorientation lifts the initial rim length the rest of the way from the partially unbent configuration (resulting from insertion of the tip of the end wedge 60) to a fully open state (resulting from insertion of the tip of the intermediate wedge 62).

As used herein and in the claims, the term “partial rotation” or “reorientation” is intended to encompass not merely the exact substitution of a segment of the intermediate wedge 62 for the end wedge 60 (so that there is in effect no lateral movement of the device 10), but also the pivoting of the device about an axis through the end wedge 60 (so that the partial rotation or reorientation causes the device 10 to extend somewhat further along its path of lateral travel between the remaining rim length 44 and the remaining cover length 46). After the partial rotation or reorientation, the smooth transition of the upper surfaces 66, 68 facilitates forcible lateral movement of the intermediate wedge 62 between the remaining length of the rim 44 and the remaining length of the cover margin 46 to unbend the remaining rim length 44 until it no longer substantially overlaps the cover margin length 46.

In a preferred embodiment, the intermediate wedge 62 has a compound curvature of its own and is formed to have a variable wedge angle, the intermediate wedge angle being smallest at each lateral end thereof and progressively increasing towards the central or middle portion thereof. Just as the compound curvature of the groove 26 facilitated the lateral movement step in the closing process, the compound curvature of the intermediate wedge 62 facilitates the lateral movement step in the opening process. Thus, during the lateral movement step of the opening process, the abutting faces of the remaining rim length 44 and remaining cover length 46 are initially partially separated at all points along the travel path first by the relatively flat tip of the end wedge 60, and then rim 16 is further unbent by the somewhat flat upper surface 68 of a lateral end of the intermediate wedge, and then finally lifted to the fully unbent state by the blunt front tip of the intermediate wedge middle portion. Preferably the intermediate wedge 62 is configured and dimensioned to unbend the rim 16 to an orientation at least substantially perpendicular to the ledge 24 and cover 20 so that the cover 20 may be easily removed therefrom.

The device is equally well adapted for use by both right- and left-handed persons, as the preferred embodiment has an end wedge at each lateral end thereof and the lateral movement step may be performed in either direction.

It will be appreciated that the opening and closing processes described hereinabove using the device 10 are safe since the user's hand contacts the container, if at all, only to maintain the same stationary, while the device is pressed or inserted thereon and then moved laterally therearound, or to rotate the container after the initial pressing or insertion step to effect the lateral movement step.

It will also be appreciated that, for the purposes of the present invention, it is irrelevant whether, during the initial step, the device 10 is pressed onto a stationary storage container 14 or the storage container 14 is pressed into a stationary device 10, and whether the device 10 is inserted between a stationary storage container 14 and cover 20 assembly or whether the assembly 14/20 is inserted onto a stationary device 10. Similarly, it is irrelevant whether, during the lateral movement step, whether the device 10 is laterally moved about a stationary container 14 or whether the container 14 is laterally moved about a stationary device 10. Accordingly, any reference herein or in the claims to the pressing of one object onto another, the insertion of one object into another, or the movement of one object about another, should be deemed to be only a reference to relative movement of the two objects rather than an indication of one object being moved relative to a stationary object. Indeed, such terminology should be deemed to encompass the simultaneous movement of both objects in opposite directions.

While the need to overcome friction is only a minor component of the force required to effect the desired relative movement of the device 10 and the storage container 14, preferably the device 10 is formed of plastic, wood or like rigid substances having a low coefficient of friction. Indeed, one or more rotatable members (not shown) may be disposed on at least one (and preferably both) of the facing surfaces of the groove 26 to facilitate relative lateral movement of the device relative to the container 24 and/or on at least one (and preferably both) of the opposed surfaces of the wedge 28 (preferably the intermediate wedge 62) to facilitate such relative lateral movement. The rotatable member may be freewheeling (such as a ball bearing) or constrained to rotation about a given axis (such as a cylinder or roller).

To ensure that the device does not become mislaid or lost in a commercial establishment, and to facilitate use thereof in either a commercial establishment or a home, it may additionally include a finger ring (not shown) secured to the member for movement therewith and wearable on a user's finger.

To summarize, the present invention provides a device and process for closing a storage container using a tool or device which safely and efficiently ensures tight closure of the bent peripheral rim over a central cover margin, thereby to prevent accidental leakage from the container cavity. The present invention also provides a device and process for opening a storage container using a tool or device which safely and efficiently unbends the bent peripheral rim of the storage container to enable removal of the central cover therefrom. Finally, the present invention provides a device for safely and efficiently opening a storage container, closing a storage container, or both, as needed.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

I claim:

1. A device for closing a storage container by bending a flexible upstanding peripheral rim thereof over a margin of a central cover, comprising:
a manually operable rigid member defining a groove opening onto an outer face thereof and configured for forcibly pressing said groove onto the peripheral rim to bend an initial rim length downwardly and inwardly to overlap a corresponding length of the margin of the central cover, and for forcibly moving said groove laterally along the rim to bend the remaining rim length so as to overlap the remaining cover margin length.

2. The device of claim 1 wherein said groove is configured and dimensioned to bend the rim to an orientation substantially parallel to the cover.

3. The device of claim 1 wherein said groove is defined by a variable groove angle wherein said groove angle is greatest at each lateral end of said device and progressively decreases towards the middle thereof.

4. The device of claim 3 wherein said groove is generally V-shaped.

5. A device for opening a storage container by unbending a flexible peripheral rim thereof previously bent to substantially overlap a margin of a central cover, comprising:
a manually operable rigid member defining a wedge configured and dimensioned for forcible insertion intermediate the margin of the central cover and the overlapping peripheral rim of the storage container to unbend the perimeter of the storage container overlapping the peripheral rim as the device is laterally moved around the perimeter of the storage container.

6. The device of claim 5 wherein said wedge is configured and dimensioned to unbend the rim to an orientation at least substantially perpendicular to the cover.

7. The device of claim 5 wherein said wedge is formed to have a variable wedge angle wherein said wedge angle is smallest at each lateral end thereof and progressively increases towards the middle of said wedge.

8. The device of claim 5 wherein said member is formed of plastic having a low coefficient of friction.

9. The device of claim 5 additionally including a finger ring secured to said member for movement therewith and wearable on a user's finger.

10. The device of claim 5 additionally including a rotatable member disposed on at least one of the opposed surfaces of said wedge to facilitate lateral movement of said rigid member.

11. The device of claim 10 wherein said rotatable member is a cylindrical roller or a ball bearing.

12. The device of claim 5 wherein said manually operable rigid member defines two opposed end wedges and an intermediate wedge connecting said two end wedges, said end wedges being sharper than said intermediate wedge, said end and intermediate wedges defining a common bottom surface and separate upper surfaces, said upper surfaces of said end wedges expanding smoothly upwardly into said upper surface of said intermediate wedge and configured for (A) initially forcibly inserting at least one of said end wedges intermediate an initial length of a margin of a central cover and an initial length of a flexible overlapping peripheral rim of an aluminum storage container to unbend the initial rim length upwardly and outwardly relative to the initial cover margin length so that the initial rim length no longer substantially overlaps the initial cover margin length, and then, after partial rotation of said member to replace said one end wedge by said intermediate wedge, (B) for forcibly moving said intermediate wedge laterally intermediate the remaining length of the cover margin and the remaining length of the rim to unbend the remaining rim length so that the remaining rim length no longer substantially overlaps the remaining cover margin length.

13. A device for closing a storage container by bending a flexible upstanding peripheral rim thereof over a margin of a central cover, and for opening a storage container by unbending a flexible peripheral rim thereof previously bent to substantially overlap a margin of a central cover, comprising:
a manually operable rigid member defining a groove having an opening and a wedge having a tip;
whereby to close the container one initially forcibly presses said groove inwardly onto an initial length of an outer surface of a flexible upstanding peripheral rim of a storage container to bend the initial rim length downwardly and inwardly so that the initial rim length overlaps an initial length of a margin of a central cover and then forcibly moves said groove laterally along the remaining length of the rim to bend the remaining rim length so that it overlaps the remaining length of the cover margin; and
whereby to open the container one initially forcibly inserts at least said wedge tip intermediate an initial length of the cover margin and an initial length of the overlapping rim to unbend the rim length upwardly and outwardly relative to the cover so that the initial rim length no longer substantially overlaps the initial cover margin length and then forcibly moves at least said wedge tip laterally intermediate the remaining length of the cover margin and the remaining length of the rim to unbend the remaining rim length so that it no longer substantially overlaps the remaining cover margin length.

14. A device for opening a storage container by unbending a flexible peripheral rim thereof previously bent to substantially overlap an edge of a central cover, comprising:
a manually operable rigid member including a bottom surface defining one surface of a wedge extending between lateral ends of said member, said wedge having a variable wedge angle which is smaller at the lateral ends and progressively increases towards the front of said member, wherein one of the smaller wedge angles facilitates insertion of said member intermediate said bent rim and adjacent cover and the progressively increasing wedge angle thereafter facilitates the unbending of the bent rim as said member is moved around the storage container.

15. A device for closing a storage container by bending a flexible upstanding peripheral rim thereof over a margin of a central cover, and for opening a storage container by unbending a flexible peripheral rim thereof previously bent to substantially overlap a margin of a central cover, comprising:
a manually operable rigid member defining a groove and a wedge;
the groove having a variable groove angle which is largest at the lateral ends and progressively decreases towards the middle of said member, wherein one of the largest groove angles facilitate insertion of said member over said rim and adjacent cover, and the progressively decreasing groove angle thereafter facilitates the bending of the rim as said member is moved around the storage container;
the wedge having a variable wedge angle which is smallest at the lateral ends and progressively increases towards the front of said member, wherein one of the smallest wedge angles facilitates insertion of said member intermediate said bent rim and adjacent cover, and the progressively increasing wedge angle thereafter facilitates the unbending of the bent rim as said member is moved around the storage container.

16. A process for closing a storage container by bending a flexible upstanding peripheral rim thereof over a margin of a central cover, comprising the steps of:
(A) providing a manually operable rigid device defining a generally V-shaped groove opening onto an outer face thereof;
(B) initially forcibly pressing the groove of the device inwardly onto an initial length of an outer surface of a flexible upstanding peripheral rim of a storage container to bend the initial rim length downwardly and inwardly so that the initial rim length overlaps an initial length of a margin of a central cover;
(C) then forcibly moving the groove of the device laterally along the remaining length of the rim to bend the remaining rim length so that it overlaps the remaining length of the cover margin; and
(D) finally separating the device and the container.

17. A process for opening a storage container by unbending a flexible peripheral rim thereof previously bent to substantially overlap a margin of a central cover, comprising the steps of:
(A) providing a manual operable rigid device defining a wedge having a tip;
(B) initially forcibly inserting at least the tip of the wedge intermediate an initial length of a margin of a central cover and an initial length of a bent flexible peripheral overlapping rim of a storage container to unbend the initial rim length upwardly and outwardly relative to the initial cover margin length so that the initial rim length no longer substantially overlaps the initial cover margin length;
(C) then forcibly moving at least the wedge tip laterally intermediate the remaining length of the cover margin and the remaining length of the rim to unbend the remaining rim length so that the remaining rim length no longer substantially overlaps the remaining cover margin length; and
(D) finally separating the device and the container.

18. The process of claim 17 wherein the wedge is sharp at each lateral end of the device and relatively blunt intermediate the lateral ends of the device, and the initial insertion step involves insertion of a sharp wedge end, followed by partial rotation of the device to forcibly insert the blunt intermediate portion of the wedge.

19. The process of claim 17 wherein the wedge is flat at each lateral end of the device and thick intermediate the lateral ends of the device.

20. In combination,
(A) a container/cover assembly including:
(i) a storage container having a flexible upstanding peripheral rim, and
(ii) a central cover having a peripheral margin;
said rim being bendable to substantially overlap said cover margin, thereby to close said container with said cover and, when previously so bent, being unbendable to not substantially overlap said cover margin, thereby to open said container for removal of said cover therefrom; and
(B) a manually operable rigid device defining
(i) a groove with an opening, and
(ii) a wedge with a tip;
whereby to close said container about said cover initially one forcibly presses said groove inwardly onto an initial length of an outer surface of said rim to bend said initial rim length downwardly and inwardly so that said initial rim length overlaps an initial length of said cover margin, and then forcibly moves said groove laterally along the remaining length of said rim to bend said remaining rim length so that it overlaps the remaining length of said cover margin; and
whereby to open said container for removal of said cover initially one forcibly inserts at least said wedge tip intermediate an initial length of said cover margin and an initial length of said overlapping rim to unbend said initial rim length upwardly and outwardly relative to said cover so that said initial rim length no longer substantially overlaps said initial cover margin length, and then forcibly moves at least said wedge tip laterally intermediate the remaining length of said cover margin and the remaining length of said rim to unbend said remaining rim length so that it no longer substantially overlaps said remaining cover margin length.
